(19) United States
(12) Patent Application Publication
(10) Pub. No.: US 2010/0153523 A1
(43) Pub. Date: Jun. 17, 2010

(54) SCALABLE INTERCONNECTION OF DATA CENTER SERVERS USING TWO PORTS

(75) Inventors: Dan Li, Beijing (CN); Chuanxiong Guo, Nanjing (CN); Kun Tan, Beijing (CN); Haitao Wu, Beijing (CN); Yongguang Zhang, Beijing (CN)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/336,228

(22) Filed: Dec. 16, 2008

(51) Int. Cl. G06F 15/173; G06F 15/16

(52) U.S. Cl. 709/220; 709/228; 709/241

(57) ABSTRACT

Large numbers of commodity servers in a data center may be inexpensively interconnected using low-cost commodity network switches, a first network port on each commodity server, a second network port on each commodity server, and a traffic-aware routing module executed on each commodity server. Connecting two or more commodity servers via the first network ports on each server to a commodity network switch forms a unit. Connecting two commodity servers in different units forms a group. Each unit has a direct connection via a second network port on a commodity server in the unit to another unit. Each group may have a direct connection via a second network port on a commodity server in the group to another group. Traffic-aware routing modules executed on each commodity server determine routing of data between servers and balance traffic across the first and second ports.

### BACKGROUND

Governments, companies, educational institutions, and others increasingly rely on large numbers of computers located in data centers. These data centers may comprise hundreds or even thousands of interconnected servers.

Interconnecting these servers has traditionally been an expensive prospect. A tree-based interconnection infrastructure relied on multiple servers feeding commodity switches which in turn feed traffic into high-capacity switches. However, high-capacity switches are expensive and introduce a single point of failure for the servers which depend from them. Placement of additional redundant switches to minimize the single point of failure further increases the cost.

Furthermore, continuous data center growth is expected. This growth in the number of servers in a data center may exceed the capacity and cost effectiveness of existing infrastructures.

### SUMMARY

As described above, data centers are growing to incorporate an ever increasing numbers of servers. The interconnections between those servers have required expensive hardware with finite limits regarding how many servers may be interconnected.

Disclosed is a method for interconnecting servers in a highly scalable interconnection structure which utilizes low-cost network infrastructure hardware. The resulting interconnection structure results in relatively low diameter, that is the maximum distance between two servers is relatively low relative to the overall size of the structure. Thus the interconnection structure is able to support real-time applications, as well as exhibiting a high bisection width indicating robust link fault tolerance.

### BRIEF DESCRIPTION OF THE DRAWINGS

The disclosure is made with reference to the accompanying figures. In the figures, the left most reference number digit identifies the figure in which the reference number first appears. The use of the same reference numbers in different figures indicates similar or identical terms.

FIG. 1 is an illustrative diagram of an interconnection structure of data center servers depicting three units, each unit having a switch and four servers, and a level-1 group having three units.

FIG. 2 is an illustrative diagram depicting an interconnection structure comprising four level-1 groups interconnected to form a level-2 group.

FIG. 3 is an illustrative flow diagram of building an interconnection structure between servers.

FIG. 4 is an illustrative flow diagram of using the interconnection structure built in FIG. 3.

FIG. 5 is an illustrative flow diagram of a traffic-aware routing module used to route network traffic through the interconnection structure of FIG. 3.

### DETAILED DESCRIPTION

Large numbers of servers can be inexpensively interconnected using low-cost commodity network switches, a first network port on each commodity server, a second network port on each commodity server, and a traffic-aware routing module executed on each commodity server.

Connecting two or more servers, including commodity servers, via the first network port on each server to a commodity network switch forms a “unit.” Connecting two commodity servers of different units via the second network ports forms a “group.” Each unit has a direct connection to another unit via the second network port on a server in the unit. Additionally or alternatively, each group may have a direct connection via a second network port on the server in the group to another group. Traffic-aware routing modules executing on each commodity server use a greedy approach to determine routing of data between servers and to balance traffic across the first and second network ports. Using this greedy approach results in optimizing each traffic-aware routing module's individual output with low computational overhead computationally while providing good overall performance across the interconnection structure.

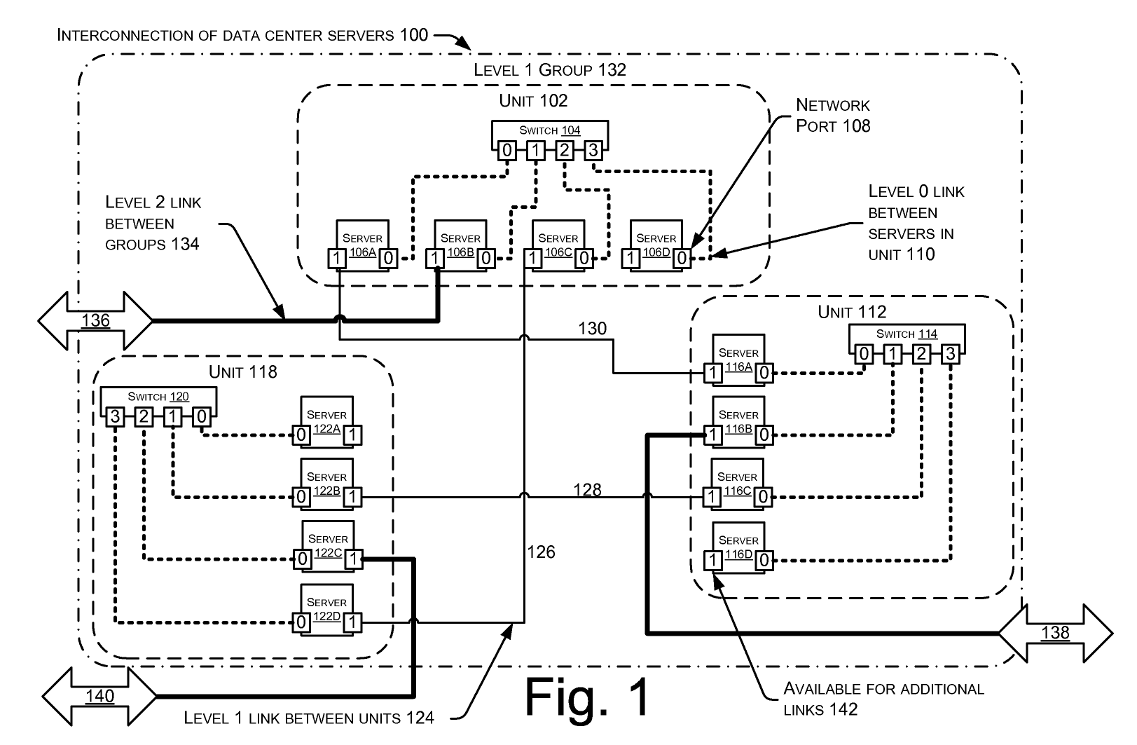

FIG. 1 is an illustrative diagram depicting an interconnection structure 100 of data center servers according to one implementation. In this illustration, a unit 102 comprises a four port network switch 104 or other network interconnection infrastructure or device such as a hub, daisy chain, token ring, etc. Within unit 102 are four servers: 106A, 106B, 106C, and 106D. For ease of reference, 106N used in this application designates any of servers 106A-D, or another server in the same unit that is connected to the same switch by a first network port. Each server 106N has two network ports 108, a first network port (port “0”) and a second network port (port “1”). The network ports may employ an Ethernet or other communication protocol. Each server 106N connects from the first network port to the switch 104 within server 106N's unit 102, with this link designated a level-0 link 110. While the servers depicted in this illustration show two network ports, in other implementations, servers having more than two network ports may also be used.

Similar to unit 102, unit 112 comprises a four port switch 114 connected via level-0 links 110 to the first network ports on servers 116A, 116B, 116C, and 116D.

Similar to unit 102 above, unit 118 comprises a four port switch 120 connected via level-0 links 110 to the first network ports on servers 122A, 122B, 122C, and 122D.

Units are connected via level-I links 124 between second network ports on servers in different units. In this application, at levels 1 and greater, one-half of all available servers may link to servers at a same level. An available server is one which has a second network port unused.

For example, before interconnection, unit 102 has four available servers (106A-106D) as none have their second ports in use. One-half of these four is two. Therefore, two servers from each unit having four servers may be used as unit-connecting servers to link with other units at a same level. In this example, four servers in each unit results in a group limited to three units.

These links to other units are illustrated as follows: Level-1 link 126 connects from the second port on server 122D in unit 118 to the second port on server 106C in unit 102. Level-1 link 128 connects from the second port on server 122B in unit 118 to the second port on server 116C in unit 112. Level-1 link 130 connects from the second port on server 106A in unit 102 to the second port on server 116A in unit 112. Thus, each unit has one direct level-1 link to every other unit and forms a level-1 group 132.

Groups may link to other groups in similar fashion, with one-half of all available servers used for linking. In this example, after accounting for the level-1 links, there are six available servers: 106B and 106D in unit 102, 116B and 116D in unit 112, and 122A and 122C in unit 118. One-half of these six available servers may provide links, providing three links to other groups. Links are distributed across units or groups to prevent more than a single server in one unit or group from connecting to the other unit or group.

For example, server 106B in unit 102 may provide one end of a level-2 link 134 between groups, leading to connection 136 described in more depth below. Similarly, server 116B in unit 112 may provide one end of a level-2 link 134 between groups, leading to connection 138, also described in more depth below. Finally, server 122C in unit 118 may provide one end of a level-2 link 134 between groups, leading to connection 140, also described below. Thus, in this example three links to three different groups at the same level are possible. Note that this arrangement leaves servers 116D, 106D, and 122A available for additional links 142.

These available additional links 142 are a result of constructing an interconnection structure in the fashion described in FIG. 1. At each level of interconnection, additional servers remain available for interconnection, thus the interconnection structure is never closed. A “diameter” of the interconnection structure is a maximum distance between two nodes (such as servers). The diameter of this interconnection structure is small relative to the number of nodes. This small diameter means this interconnection structure can support applications with real-time requirements because data sensitive to delay has a minimum number of hops between nodes. This interconnection structure, for example, may have an overall diameter which is relatively small, with an upper bound of 2^{k+1} where k is the level of a server and the level generally starts at 0 and increasing by integer values, i.e., 1, 2, 3, 4, etc.

Additionally, the exponential nature of the interconnection structure allows rapid scaling to large numbers of servers. For example, if 48 port switches are used instead of the four port switches described above, a two level interconnection structure may support 361,200 servers. Given this exponential nature, the number of levels may be relatively small, such as 2 or 3, thus resulting in a relatively small overall diameter as described above. Furthermore, use of the second network port, traditionally thought of as a “backup” port, does not adversely affect reliability of a server in the event a failure of one of the network ports. This is because the server still may use the remaining network port to carry traffic.

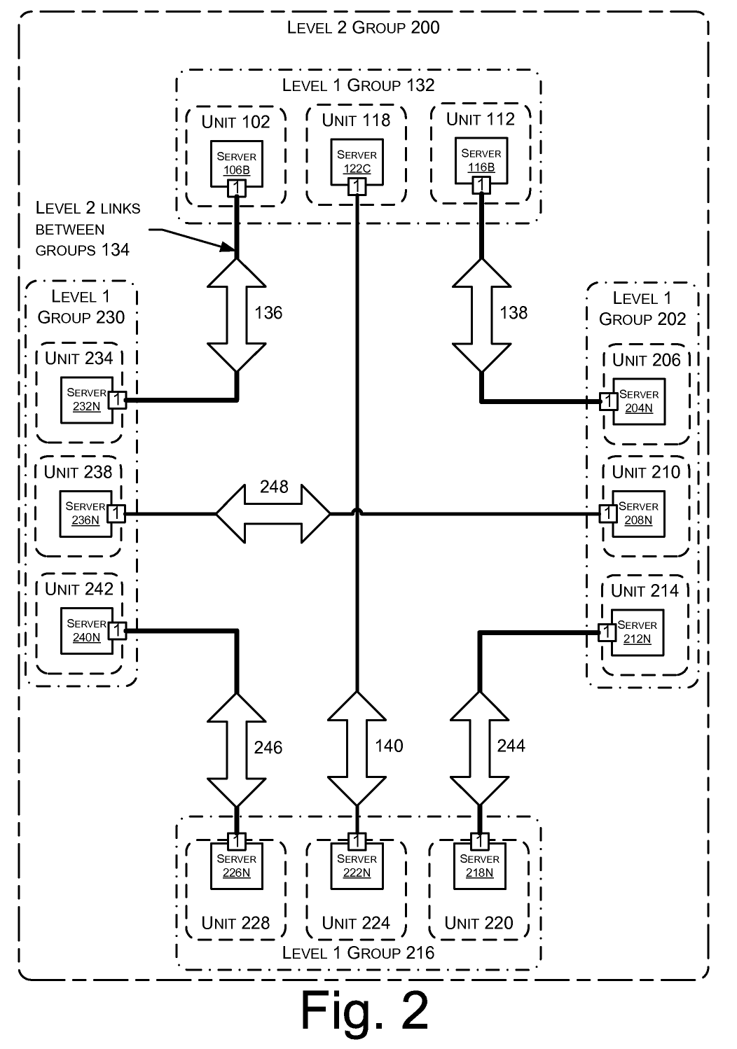

FIG. 2 is an illustrative diagram depicting a simplified interconnection structure comprising four level-1 groups, including the level-1 group of FIG. 1, interconnected to form a level-2 group 200. Omitted for clarity in this illustration is the first network port (port “0”) on each server as well as the associated level-0 links and switches. Also omitted for clarity in this illustration are the level-1 links interconnecting units of a group. Each server illustrated is a group-connecting server having a second network port available for connection to another group at the same level.

In addition to the level-1 group 132 as described above in FIG. 1, the following level-1 groups and their constituents are illustrated:
Level-1 group 202 comprises server 204N in unit 206, server 208N in unit 210, and server 212N in unit 214.
Level-1 group 216 comprises server 218N in unit 220, server 222N in unit 224, and server 226N in unit 228.
Level-1 group 230 comprises server 232N in unit 234, server 236N in unit 238, and server 240N in unit 242.

Interconnecting level-1 groups forms a level-2 group 200. One server from each group connects to a server in a different group. No connections are duplicated, i.e., a group does not directly connect more than once to another group. In this example the connections are as follows:
Level-2 link 136 connects server 106B in unit 102 of level-1 group 132 and server 232N in unit 234 of level-1 group 230.
Level-2 link 138 connects server 116B in unit 112 of level-1 group 132 and server 204N in unit 206 of level-1 group 202.
Level-2 link 140 connects server 122C in unit 118 of level-1 group 132 and server 222N in unit 224 of level-1 group 216.
Level-2 link 244 connects server 218N in unit 220 of level-1 group 216 and server 212N in unit 214 of level-1 group 202.
Level-2 link 246 connects server 226N in unit 228 of level-1 group 216 and server 240N in unit 242 of level-1 group 230.
Level-2 link 248 connects server 236N in unit 238 of level-1 group 230 and server 208N in unit 210 of level-1 group 202.

Pseudo-code describes the building of the recursively defined interconnection structure of this application. The following variables are defined as:
k is the level of a server, the level generally starting at 0 and increasing by integer values, i.e., 1, 2, 3, 4, etc.
Unit₀ is the basic construction unit comprising n servers and an n-port switch connecting the n servers. Typically n is an even number, although odd numbers are possible, and may occur during use. For example, when four servers are used and one fails, the Unit₀ now comprises three servers.
Groupₖ is the collection of a plurality of Unit₀'s, where k>0.
b is a count of the servers with available second network ports.
gₖ is the number of k−1 level groups in a Groupₖ, and equals b/2+1
N_{L} is the number of linking servers, which is b/2.
uₖ, a sequential number, may be used to identify a server s in a Groupₖ. Assuming the total number of servers in a Groupₖ is Nₖ, then 0≦uₖ<Nₖ.

Using these variables, the following pseudo-code constructs Groupₖ (where k>0) upon gₖ*Groupₖ₋₁ groups. In each Groupₖ₋₁, the servers satisfying

(uₖ₋₁−2^{k-1}+1)mod 2^{k}==0 (Equation 1)

are selected as level-k servers and interconnected as described in pseudo-code 1 below.

Pseudo-code 1.

01 InterconnectionConstruct(k){
02 for(i₁ = 0; i₁ < gₖ; i₁ + +)
03 for (j₁ = i₁ * 2^{k} + 2^{k-1} − 1; j₁ < Nₖ₋₁ ; j₁ = j₁ + 2^{k})
04 i₂ = (j₁ − 2^{k-1} + 1) / 2^{k} + 1
05 j₂ = i₁ * 2^{k} + 2^{k-1}) − 1
06 connect servers [i₁,j₁] with [i₂,j₂]
07 return
08 }

This interconnection structure allows for routing via multiple links. For example, data flow may have a source of server 122A and a destination of 212N. In this example, the data flow could traverse the following route:
122A to 122B via a level-0 link,
122B to 116C via a level-1 link,
116C to 116B via a level-0 link,
116B to 204N via level-2 link 138,
204N to 204X (not shown) in the same unit via a level-0 link, where 204X has a level-1 link to a server 212Y in unit 214;
212Y (not shown) to 212N via a level-0 link.

The interconnected nature of the network provides robustness and redundancy. Should a level-2 link fail, data flow may still flow to a destination via other level-2 links. For example, assume level-2 link 138 fails or has insufficient bandwidth. One alternate route could comprise:
122A to 122C via a level-0 link,
122C to 222N via level-2 link 140,
222N to 222Y (not shown) in the same unit via a level-0 link, where 222Y has a level-1 link to a server 218Z in unit 220;
218Z to 218N via a level-0 link;
218N to 212N via a level-2 link.
122C to 116C via a level-1 link,
116C to 116B via a level-0 link,
116B to 204N via level-2 link 138,
204N to 204X (not shown) in the same unit via a level-0 link, where 204X has a link to a server 212Y in unit 214;
212Y (not shown) to 212N via a level-0 link.

Because each element, such as a server, a unit, or a group, in the interconnected structure has two connections, alternate routes remain available so long as one of those two connections is functional. A bisection width of an interconnection structure is the minimum number of links that can be removed to break it into two equally sized disconnected networks. In the case of the interconnection structure described in this application, the lower bound of the bisection width of a Groupₖ is determined as follows:

$$Bisection width = \frac{{N}_{k}}{( 4 * {2}^{k} )} where {N}_{k} is the total number of servers in {Group}_{k} . \qquad ( Equation 2 )$$

This high bisection width indicates many possible paths exist between a given pair of servers, illustrating the inherent fault tolerance and possibility to provide multi-path routing in dynamic network environments, such as data centers.

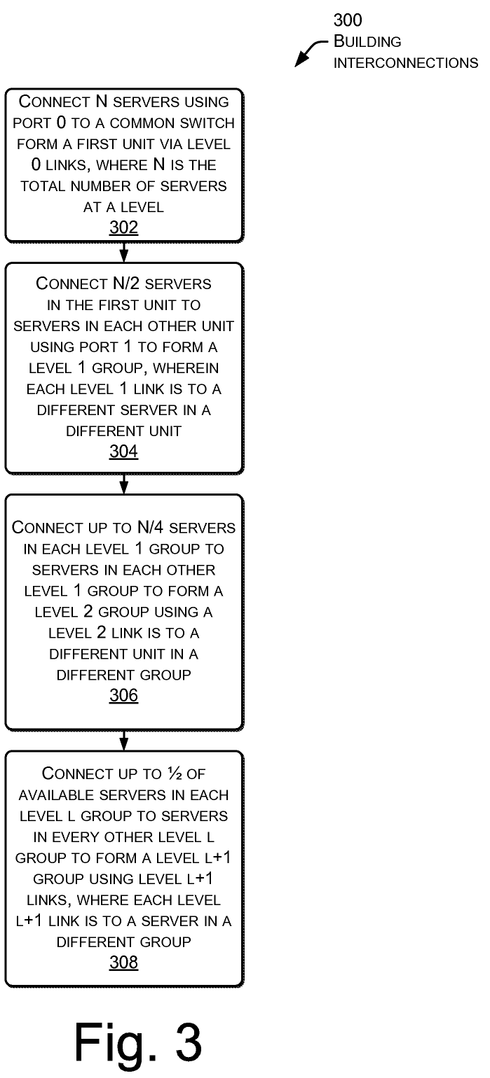

FIG. 3 is an illustrative flow diagram of building interconnections between servers 300 as described above. At 302, N servers are connected using port 0 to a common switch to form a first unit at level-0, where “N” is the total number of servers at a level “L”.

At 304, N/2 servers in the first unit are connected via level-1 links to servers in each other unit using port 1 forming a level-1 group, wherein each level-1 link is to a different server in a different unit.

At 306, N/4 servers are connected via level-2 links in each level-1 group to servers in each other level-1 group to form a level-2 group, wherein each level-2 link is to a different server in a different group.

At 308, levels may continue to be added by connecting up to one-half of all available servers in each level “L” group to available servers in every other level L group to form a level L+1 group using level L+1 links, where each level L+1 link is to a server in a different group.

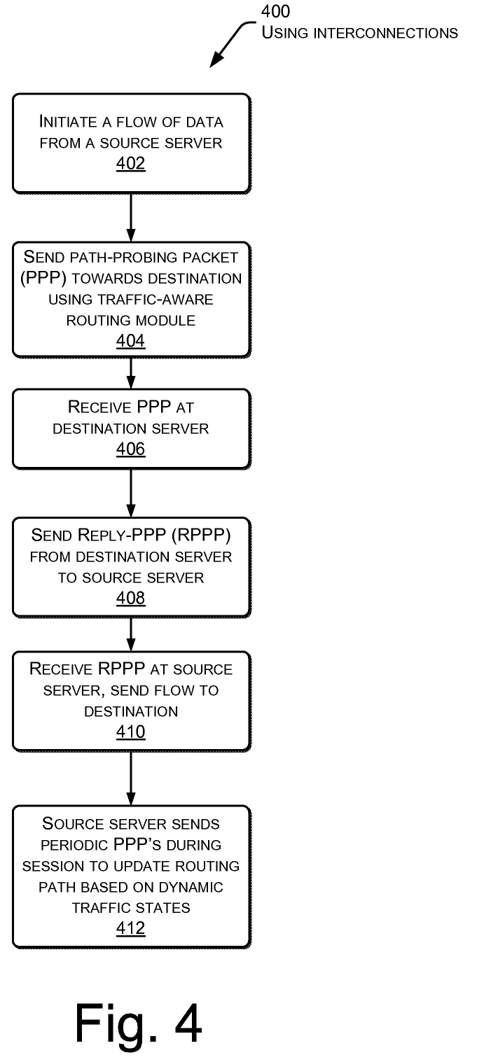

FIG. 4 is an illustrative flow diagram of using the interconnections 400 built in FIG. 3. At 402, a source server initiates a flow of data to a destination server. For example, a server may have completed a processing task and is now returning processed data to a coordination server.

At 404, the source server sends a path-probing packet (PPP) towards the destination server using a traffic-aware routing (TAR) module. TAR provides effective link utilization by routing traffic based on dynamic traffic state. TAR does not require a centralized server for traffic scheduling, eliminating a single point of failure. TAR also does not require the exchange of traffic state information among even neighboring servers, thus reducing network traffic. Each intermediate server uses a TAR module to compute a traffic-aware path (TAP) on a hop-by-hop basis, based on available bandwidth of each port on the intermediate server. TAR will be discussed in more depth later in this application.

The PPP may also incorporate a progressive route (PR) field in the packet header. The PR field prevents problems with routing back and multiple bypassing. The routing back problem arises when an intermediate server chooses to bypass its level-L (where L>0) link and routes the PPP to a next-hop server in the same unit, which then routes the same PPP back using level-recursive routing, forming a loop. The multiple bypassing problem occurs when one level-L (where L>0) link is bypassed, and a third server at a lower level is chosen as the relay and two other level-L links in the current level will be bypassed. However, the two level-L links may need to be bypassed again, resulting in a path which is too long or potentially generating a loop.

The PR field prevents these problems by providing a counter for the TAR. Intermediate servers may modify the PR field. A PR field may have m entries, where m is the lowest common level of the source and destination servers. PR_{L} denotes the Lth entry of PR field, where (1≦L≦m). Each PR_{L} plays two roles: First, when bypassing a level-L link, the level-L server in a selected third Group_{(L-1)} is chosen as a proxy server and is set in the PR_{L}. Intermediate servers check the PR field and route the packet to the lowest-level proxy server. Thus, the PPP will not be routed back.

Second, PR_{L} may carry bypass information about bypassing in the current Group_{L}. If a number of bypasses exceeds a bypass threshold, the PPP jumps out of the current Group_{L} and another Group_{L} is chosen for relay. Generally, the higher the bypass threshold, the more likely that the PPP finds a balanced path because with a higher bypass threshold there are more opportunities to find a lower-utilized link within a group.

For example, where the bypass threshold is 1, two special identifiers for a PR_{L} may be specified: BYZERO and BYONE. These special identifiers are different from server identifiers. BYZERO indicates no level-L link is bypassed in the current Group_{L}, so PR_{L} is set to BYZERO when the packet is initialized or after crossing a level-i link if i>L. The BYONE value indicates there is already one level-L link bypassed in the current Group_{L}, so PR_{L} is set to BYONE after traversing the level-L proxy server in the current Group_{L}. PR_{L} is set as the identifier of the level-L proxy server between the selection of the proxy server and the arrival to the proxy server. The source server initializes the PR entry in a PPP as BYZERO.

At 406, the destination server receives a PPP. Once received, at 408 the destination server sends a reply-PPP (RPPP) back to the source server by exchanging the original PPP's source and destination fields.

At 410, the source server's receipt of the RPPP confirms that a path is available for transmission, and data flow may begin. Intermediate servers then forward the flow based on established entries in their routing tables built during the transit of the PPP.

At 412, periodically during a data transfer session between the source and destination server, a PPP may be sent to update the routing path. This update provides for changing the routing path based on dynamic traffic states within the interconnection structure. For example, failures or congestion elsewhere in the network may render the original routing path less efficient than a new path determined by the TAR. Thus, the PPP updates provide a mechanism to discover new paths in response to changing network conditions during a session.

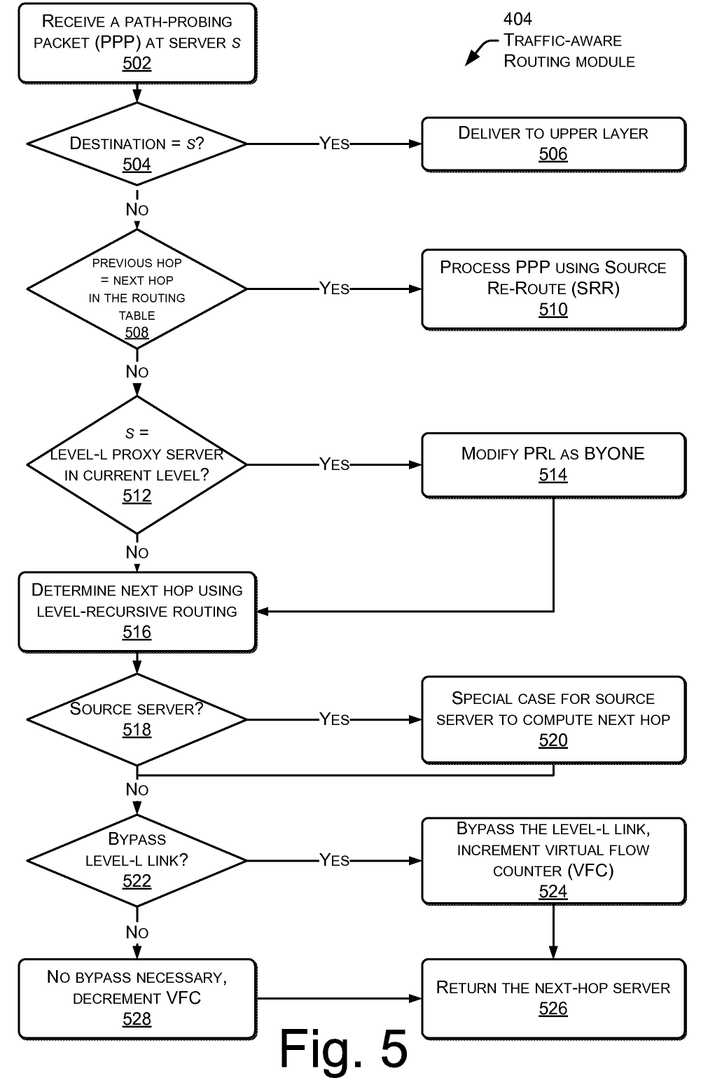

FIG. 5 is an illustrative flow diagram of a traffic-aware routing module 404. At 502, at server s a TAR module (TARM) receives a PPP. At 504, when the destination server is server s, the TARM delivers the PPP to an upper layer 506 in a processing system. This processing system may be a protocol manager module, application module, etc.

Where the destination server is not server s, at 508 the TARM tests whether a previous hop for the PPP is equal to a next hop in a routing table, and if so, processes the PPP using a Source Re-Route (SRR) module 510. SRR provides a mechanism for a PPP to bypass a busy or non-functional link.

When a server s decides to bypass its level-L (where L>0) link and choose a proxy server, server s may modify the PR field and re-route the PPP back to the previous hop from which server s received the packet. Original intermediate servers from the source server to s will then all receive the PPP from the next hop server for the flow in the routing table. The source server receives the PPP packet, and clears the routing entry for the flow, then re-routes the PPP to a lowest-level proxy server in the PR field for the PPP.

At 512, when s=level-L proxy server in the current level, the PR_{L} is modified to BYONE at 514. Once PR_{L} has been modified, or when s is not equal to the level-L proxy server in the current level, at 516 the next hop is determined using level-recursive routing. Another implementation is to randomly select a third Group_{L-1} server when the outgoing link using level-recursive routing is the level-L link and the available bandwidth of the level-0 link is greater. This randomly selected third Group_{L-1} server then relays the PPP.

Level-recursive routing at 516 comprises determining the next hop in the route. A lowest-level proxy server in the PR field of the PPP is returned. When no proxy server is present, the destination server of the packet is returned and the next hop towards the destination is computed using level-recursive routing. In the case of a server s routing a packet to a desired destination dst, a recursively computed routing may be described with the following pseudo code:

Pseudo-code 2.

/*s: current server.
dst: destination server of the packet to be routed
*/
01 LRRoute(s,dst){
02 l = lowestCommonLevel(s,dst)
03 if(l == 0)
04 return dst
05 (i₁,i₂) = getLink(s,dst,l)
06 if(i₁ == s)
07 return i₂
08 return LRRoute(s,i)
09 }

At 518, when at a source server for a PPP, at 520 this special case for computing the next hop at the source server occurs. A source server selects the level-L neighboring server as the next hop when the next hop determined using level-recursive routing is within the same unit but the available bandwidth of the unit's level-L link is greater than that of the unit's level-0 link. Computation of the available bandwidth includes consideration of a virtual flow.

Virtual flow (VF) alleviates an imbalance trap problem. Assume that a level-L server s routes a flow a level-L outgoing link and there is no traffic in its level-0 outgoing link. All subsequent flows that arrive from the level-0 incoming link will bypass the level-L link because the available bandwidth of the level-0 outgoing link is always higher. In this case, the outgoing bandwidth of the level-L link cannot be well utilized even though the other level-L links in the Group_{L} are heavily loaded. This imbalance trap problem results from the idea that the TAR seeks to balance the local outgoing links of a server, not links among servers.

VF compares the available bandwidth between two outgoing links. VFs for a server s indicate flows that once arrived at s from the level-0 link but are not routed by s because of bypassing. That is, s is removed from the path by SRR. Each server initializes a Virtual Flow Counter (VFC) at 0. When a flow bypasses a level-L link, VFC is incremented by one. A non-zero VFC is reduced by one when a flow is routed by the level-0 outgoing link.

Available bandwidth of an outgoing link and virtual flows for the level-0 link are considered when evaluating available bandwidth. Setting the traffic volume of a virtual flow to the average traffic volume of routed flows avoids the imbalance trap problem.

When a proxy server is found which bypasses the level-L link of s, the PR field is updated and a next hop towards the proxy server returned. At 522, when bypassing a level-L link, at 524, the level-L link is bypassed and the VFC is incremented and the next-hop server is returned at 526. When no proxy server is found, the level-L link is not bypassed. When no bypass of a level-L link is necessary at 522, then at 528 the VFC is decremented.

This process may also be described using the following pseudo-code:

Pseudo-code 3

/*s: current server.
l: the level of s, (l > 0)
RTable: the routing table of s, maintaining the previous hop
(.prevhop) and next hop (.nexthop) for a flow.
hb: the available bandwidth of the level-l link of s.
zb: the available bandwidth of the level-0 link of s.
hn: the level-l neighboring server of s.
vfc: virtual flow counter of s.
pkt: the path-probing packet to be routed, including flow id
(.flow), source (.src), destination (.dst), previous hop (.phop), and PR field
(.pr).
*/
01 TARoute(s, pkt) {
02 if (pkt.dst == s) /*This is the destination */
03 return NULL /*Deliver pkt to upper layer */
04 if (pkt.phop == RTable[pkt.flow].nexthop) /*SRR*/
05 nhop = RTable[pkt.flow].prevhop
06 RTable[pkt.flow] = NULL
07 if (nhop ≠ NULL) /*This is not source server */
08 return nhop
09 if (s == pkt.pr[l]) /*This is the proxy server*/
10 pkt.pr[l] = BYONE
11 ldst = getPRDest(pkt) /*Check PR for proxy server */
12 nhop = LRRoute(s,ldst)
13 if (s == pkt.src and nhop ≠ hn and hb > zb)
14 nhop = hn
15 if (pkt.phop == hn and nhop ≠ hn) or
(pkt.phop ≠ hn and hb ≧ zb)
16 resetPR(pkt.pr, l)
17 RTable[pkt.flow] = (pkt.phop, nhop)
18 if(nhop ≠ hn and vfc > 0)
19 vfc = vfc − 1 /*VF*/
20 return nhop
21 fwdhop = nhop
22 while (fwdhop == nhop)
23 fwdhop = bypassLink(s, pkt, l) /*Try to bypass*/
24 if (fwdhop == NULL) /*Cannot find a bypassing path*/
25 resetPR(pkt.pr, l)
26 RTable[pkt.flow] = (pkt.phop, nhop)
27 return nhop
28 vfc = vfc +1 /*VF*/
29 return pkt.phop /*Proxy found, SRR*/
30 }

Although specific details of illustrative systems and methods are described with regard to the figures and other flow diagrams presented herein, it should be understood that certain acts or elements of the systems and methods shown in the figures need not be performed in the order described, and may be modified, and/or may be omitted entirely, depending on the circumstances. As described in this application, modules may be implemented using software, hardware, firmware, or a combination of these. Moreover, the acts and methods described may be implemented by a computer, processor or other computing device based on instructions stored on memory, the memory comprising one or more computer-readable storage media (CRSM).

The CRSM may be any available physical media accessible by a computing device to implement the instructions stored thereon. CRSM may include, but is not limited to, random access memory (RAM), read-only memory (ROM), electrically erasable programmable read-only memory (EEPROM), flash memory or other solid -state memory technology, compact disk read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by a computing device.

We claim:

1. A method of interconnecting servers in a datacenter, the method comprising:
connecting two or more servers to form a unit, each server having a first network port and a second network port, wherein the first network port on each server connects to a networking switch to form the unit;
connecting two or more units using the second network ports on the servers to form a level-1 group, the connecting comprising:
establishing a connection between two unit-connecting servers, the unit-connecting servers comprising one-half of all available servers in a unit, wherein available servers comprise servers where the second network port on the server is unconnected to another server;
limiting the connection between two unit-connecting servers to a connection between unit-connecting servers in different units, wherein only one connection is made between each pair of units; and
connecting two or more level-1 groups using the second network ports to form a level-2 group, the connecting comprising:
establishing a connection between two group-connecting servers, the group-connecting servers comprising one-half of all available servers in a group, wherein available servers comprise servers where the second network port on the server is unconnected to another server;
limiting the connection between two group-connecting servers to a connection between group-connecting servers in different groups, wherein only one connection is made between each pair of groups; and
routing data between the servers.

2. The method of claim 1, further comprising adding additional levels of groups and interconnecting the additional levels of groups using the second network port on one-half of all available servers.

3. The method of claim 1, wherein the routing data between the servers further comprises:
initiating a flow of data from a source server to a destination server;
sending a path-probing packet (PPP) towards the destination server using traffic-aware routing;
receiving the PPP at the destination server;
sending a reply-PPP (RPPP) from the destination server to the source server;
receiving the RPPP at the source server; and
sending the flow of data from the source server to the destination server.

4. The method of claim 3, wherein the traffic-aware routing comprises:
receiving the PPP at an intermediate server;
delivering the PPP to an upper layer when the intermediate server is the destination server;
processing the PPP using a source re-route (SRR) when the previous hop server equals the next hop server in a routing table for the PPP;
routing the PPP to the next hop server when the intermediate server is not the source;
modifying a progressive route (PR) field in a header to indicate a level-L link in the current unit or group has been bypassed when the intermediate server is a level-L proxy server in the current level-L;
determining the next hop server by level-recursive routing;
selecting a level-L neighboring server as the next hop server when the next hop server using level-recursive routing is within the same unit but the available bandwidth of its level-L link is greater than that of the unit's level-0 link,
selecting a level-L neighboring server as the next hop server when the next hop server using level-recursive routing is within the same unit but the available bandwidth of its level-L link is greater than that of the unit's level-0 link, wherein the available bandwidth is computed using a virtual flow;
finding a proxy server to bypass the level-L link of the intermediate server, updating the PR field, and returning the next hop towards the proxy server when bypassing a level-L link and a proxy server is available;
adding to a virtual flow counter on the intermediate server and sending the PPP to the previous hop of the flow for SRR processing when bypassing a level-L link and no proxy server is available; and
resetting the PR field and updating the routing table then returning the next hop server and reducing a virtual flow counter on the intermediate server when the previous hop server is the level-L neighboring server and the next hop server is not the same as the level-L neighboring server or when the previous hop is from the same unit and the available bandwidth of the level-L link is not less than that of the level-0 link.

5. A method of interconnecting servers, the method comprising:
connecting two or more servers to form a unit, each server having a first network port and a second network port, wherein servers in a unit are coupled to one another using the first network port of each server to form the unit;
connecting two or more units using the second network ports on unit-connecting servers to form a first group;
connecting two or more groups using the second network ports on group-connecting servers to form a larger group; and
configuring a traffic-aware routing module on each server to route data between the servers.

6. The method of claim 5, wherein the connecting two or more units comprises:
establishing a connection between two unit-connecting servers, the unit-connecting servers comprising one-half of all available servers in a unit, wherein available servers comprise servers where the second network port on the server is unconnected to another server; and
limiting the connection between two unit-connecting servers to a connection between unit-connecting servers in different units, wherein only one connection is made between each pair of units.

7. The method of claim 5, wherein the connecting two or more groups using the second network ports to form a super-group comprises:
establishing a connection between two group-connecting servers, the group-connecting servers comprising one-half of all available servers in a group, wherein available servers comprise servers where the second network port on the server is unconnected to another server; and
limiting the connection between two group-connecting servers to a connection between group-connecting servers in different groups, wherein only one connection is made between each pair of groups.

8. One or more computer-readable storage media storing instructions that when executed instruct a processor to perform acts comprising:
initiating a flow of data from a source server to a destination server;
sending a path-probing packet (PPP) towards the destination server using traffic-aware routing;
receiving the PPP at the destination server;
sending a reply-PPP (RPPP) from the destination server to the source server;
receiving the RPPP at the source server; and
sending the flow of data from the source server to the destination server.

9. The computer-readable storage media of claim 8, wherein the traffic-aware routing comprises:
receiving the PPP at an intermediate server;
delivering the PPP to an upper layer when the intermediate server is the destination server;
processing the PPP using a source re-route (SRR) when the previous hop server equals the next hop server in a routing table for the PPP.

10. The computer-readable storage media of claim 9, further comprising routing the PPP to the next hop server when the intermediate server is not the source.

11. The computer-readable storage media of claim 9, further comprising modifying a progressive route (PR) field in a header to indicate a level-L link in the current unit or group has been bypassed when the intermediate server is a level-L proxy server in the current level-L.

12. The computer-readable storage media of claim 9, further comprising determining the next hop server by level-recursive routing.

13. The computer-readable storage media of claim 9, further comprising selecting a level-L neighboring server as the next hop server when the next hop server using level-recursive routing is within the same unit but the available bandwidth of its level-L link is greater than that of the unit's level-0 link.

14. The computer-readable storage media of claim 9, further comprising selecting a level-L neighboring server as the next hop server when the next hop server using level-recursive routing is within the same unit but the available bandwidth of its level-L link is greater than that of the unit's level-0 link, wherein the available bandwidth is computed using a virtual flow.

15. The computer-readable storage media of claim 9, further comprising finding a proxy server to bypass the level-L link of the intermediate server, updating the PR field, and returning the next hop towards the proxy server when bypassing a level-L link and a proxy server is available.

16. The computer-readable storage media of claim 9, further comprising adding to a virtual flow counter on the intermediate server and sending the PPP to the previous hop of the flow for SRR processing when bypassing a level-L link and no proxy server is available; and
resetting the PR field and updating the routing table then returning the next hop server and reducing a virtual flow counter on the intermediate server when the previous hop server is the level-L neighboring server and the next hop server is not the same as the level-L neighboring server or when the previous hop is from the same unit and the available bandwidth of the level-L link is not less than that of the level-0 link.

17. A system of interconnecting servers, the system comprising:
a unit comprising a plurality of commodity servers connected to a common commodity network switch via first network ports, each commodity server having a first network port and a second network port;
a group comprising a plurality of units connected to one another using second network ports on servers within the units in the group;
a traffic-aware routing module executing on each commodity server, the traffic-aware routing module configuring the commodity server to route data between the servers.

18. The system of claim 17, wherein each server has three or more network ports.

19. The system of claim 17, further comprising two or more groups interconnected via second network ports on servers within the units in the groups.

20. The system of claim 17, wherein each unit is limited to a single connection with another unit, and each group is limited to a single connection with another unit.
